(19) United States
(12) Patent Application Publication
(10) Pub. No.: US 2013/0127636 A1
(43) Pub. Date: May 23, 2013

(54) WIRELESS SENSOR NETWORK FOR DETERMINING CARDIOVASCULAR MACHINE USAGE

(71) Applicant: CARDIBO, INC., BOSTON, MA (US)

(72) Inventors: RAMEEN ARYANPUR, MCKINLEYVILLE, CA (US); WILLIAM LANGFORD, GREENWICH, CT (US); JACKSON DOLAN, TRUMBULL, CT (US)

(73) Assignee: CARDIBO, INC., BOSTON, MA (US)

(21) Appl. No.: 13/680,865

(22) Filed: Nov. 19, 2012

Related U.S. Application Data
(60) Provisional application No. 61/561,891, filed on Nov. 20, 2011.
(60) Provisional application No. 61/561,890, filed on Nov. 20, 2011.

(51) Int. Cl. G08C 19/00

(52) U.S. Cl. CPC G08C 19/00
USPC 340/870.07

(57) ABSTRACT

To provide users the ability to track their cardiovascular exercise and determine cardiovascular exercise machine usage, the present system and methods describe an activity tracking platform. The platform includes a wireless sensor configured to monitor a piece of cardiovascular exercise equipment. The sensor can be configured and positioned to monitor a moving part of the exercise equipment, such as the spinning tread of a treadmill or the circular movement of a bike peddle. Responsive to detecting activity, the sensor can associate the data with a specific user and, using a wireless sensor network, transmit the data to a central server. The platform provides the user an associated website, where the user may view historical workout information, current exercise equipment usage at a local gym, or current workout goals.

### CROSS-REFERENCE TO RELATED PATENT APPLICATIONS

This application claims the benefit of and priority to U.S. Provisional Patent Application 61/561,890, filed Nov. 20, 2011, and U.S. Provisional Patent Application 61/561,891, filed Nov. 20, 2011, both of which are incorporated herein by reference in their entirety.

### BACKGROUND OF THE DISCLOSURE

Health and fitness center are prone to overcrowding. Gym-goers often incur lengthy and inconvenient delays to their workout as they wait for cardiovascular exercise equipment to become available. Some gyms have implemented reservation systems and time restrictions; however, the problem often still persists. In addition to avoiding to delays, many gym-goers also desire to track their exercises both in and out of the gym. Currently, there is no complete solution that allows a user to collect exercise data across multiple types of cardiovascular exercise equipment.

### SUMMARY OF THE DISCLOSURE

The present system and methods described herein provide a system and method for determining cardiovascular exercise machine usage with a wireless sensor network. A wireless sensor may be non-permanently attached to a piece of exercise equipment. The sensor may be configured and positions such that it can monitor a moving part of the exercise equipment, such as the spinning tread of a treadmill or the circular movement of a bike peddle. The sensor may then transmit the data it collects regarding the exercise equipment back to a central server. A user may then log in a website associated with the server to view current usage of the machine or to view historical data about the machine to plan the best possible workout times.

In some embodiments, a user may “log into” an exercise machine by activating a bumper associated with the exercise machine. The user may physically tap the bumper with the user's mobile device. This may create a time stamp originating from the bumper and another originating from user's device. The server may then associate subsequent exercise data from the exercise equipment with the user. The user may view live and/or historical data regarding the user's personal usage of the exercise equipment.

One aspect of the disclosure relates to a method for monitoring usage of an exercise machine and associating the usage with a user. The method includes receiving, by a server, a user identification. The method also includes the server receiving a machine identification of an exercise machine in response to an activation of a bumper. The server associates the user identification with the machine identification based on a time of receipt of the user identification and a time of receipt of the machine identification. Furthermore, the method includes receiving a data stream from a sensor sensing a moveable component of the exercise machine, and storing the data stream in association with the user identification.

In some embodiments, the sensor is at least one of an accelerometer, vibration sensor, optical sensor or magnetic field sensor. In other embodiments, the method further includes receiving, by the server, the user identification from a user's mobile device.

In yet other embodiments, the method further comprising activating the bumper by the user's mobile device, and may include transmitting the data stream to the user's mobile device. In some embodiments, the method includes generating a first time stamp associated with the user identification and a second time stamp associated with the machine identification after activation of the bumper.

In some embodiments, the data stream includes sensor data, the machine identification, and sensor status data. In other embodiments, the method includes associating the user identification with the machine identification based on the first and second time stamp. In some embodiments, the method further includes receiving the data stream prior to the receiving of the user identification. In other embodiments, the method includes associating the user identification with the machine identification based upon a GPS location of the user.

In another aspect of the disclosure, a method for monitoring usage of an exercise machine and associating the usage with a user includes monitoring, with a sensor external to an exercise machine, a moving component of the exercise machine. The method also includes transmitting, by the sensor, a data stream comprising at least one of a machine identification of the exercise machine and the sensor measurements of the moving component of the exercise machine, and transmitting, by a bumper, a machine identification and a first time stamp in response to the bumper being activated by a mobile device. The method also includes, transmitting, by the mobile device, a user identification and a second time stamp in response to the mobile device activating the bumper.

In some embodiments, the sensor is at least one of an accelerometer, vibration sensor, optical sensor and magnetic field sensor, and in some embodiments the sensor is non-permanently attached to the exercise machine. In other embodiments, the sensor goes into a sleep mode when the moving component of the exercise machine is not moving. In some embodiments, the bumper contains one of a proximity sensor and an accelerometer.

In yet other embodiments, the method includes transmitting, by the mobile device, a user GPS location. According to other embodiments, the data stream further includes a sensor status. In some embodiments, the method also includes receiving, by the mobile device, the data stream. In some embodiments the data stream is transmitted to a hub, and the hub may transmit the data stream to a server.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 is a block diagram depicting an a system for determining the usage of cardiovascular exercise machines, according to one illustrative embodiment;

FIG. 3 is a block diagram providing greater detail of a sensor depicted in FIG. 2, according to one illustrative embodiment;

FIGS. 4A and 4B is an illustrative example of a user interface for the system depicted in FIG. 2, according to one illustrative embodiment;

FIG. 5 is a flow chart of a method for monitoring the usage of cardiovascular exercise equipment with a system similar to the system depicted in FIG. 2, according to one illustrative embodiment;

FIG. 6 is a flow chart of a method for generating and using add-ons in a system similar to the system depicted in FIG. 2, according to one illustrative embodiment;

FIGS. 7A-D are block diagrams illustrating possible network configurations of the system described in FIG. 2, according to one illustrative embodiment; and

FIG. 8 is an illustration of non-limiting examples of possible sensor placements on an exercise machine, according to one illustrative embodiment.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein.
Section B describes embodiments of systems and methods for wirelessly determining the usage of cardiovascular equipment.

The various concepts introduced above and discussed in greater detail below may be implemented in any of numerous ways, as the described concepts are not limited to any particular manner of implementation. Examples of specific implementations and applications are provided primarily for illustrative purposes.

### A. Computing and Network Environment

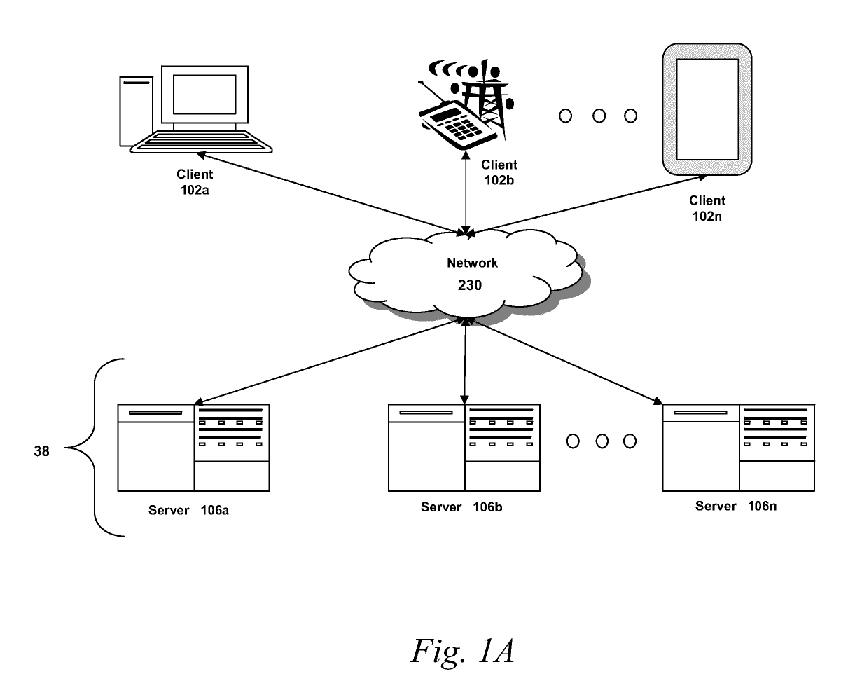

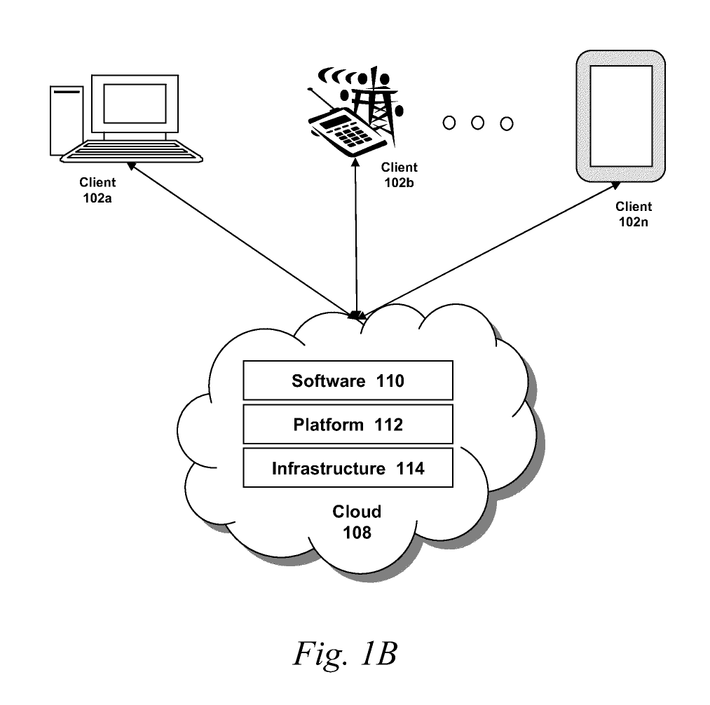

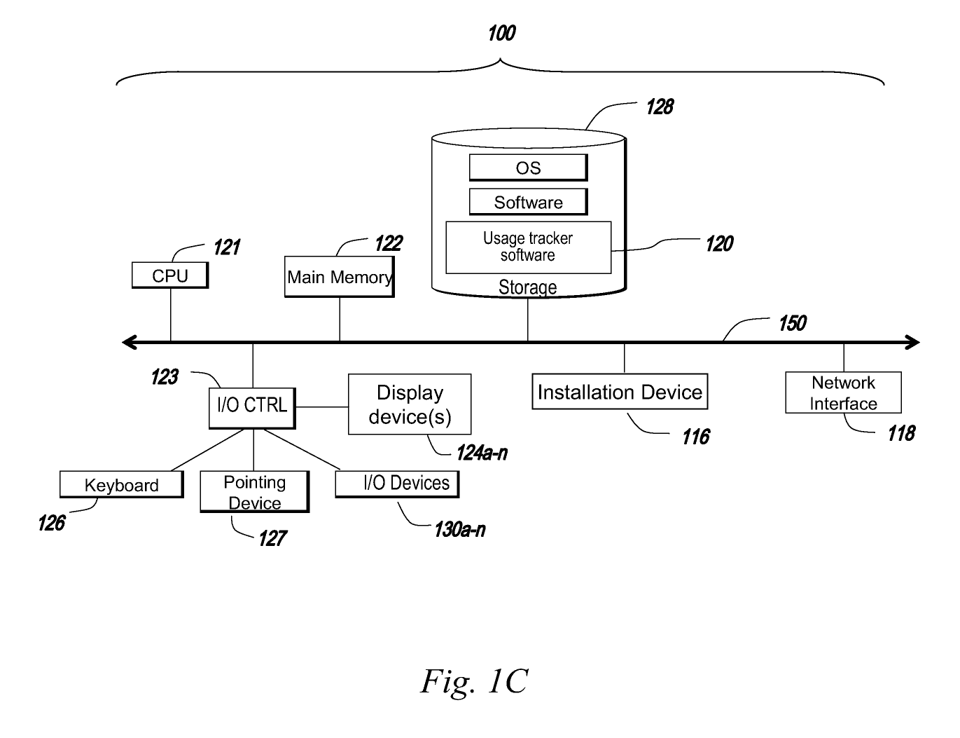

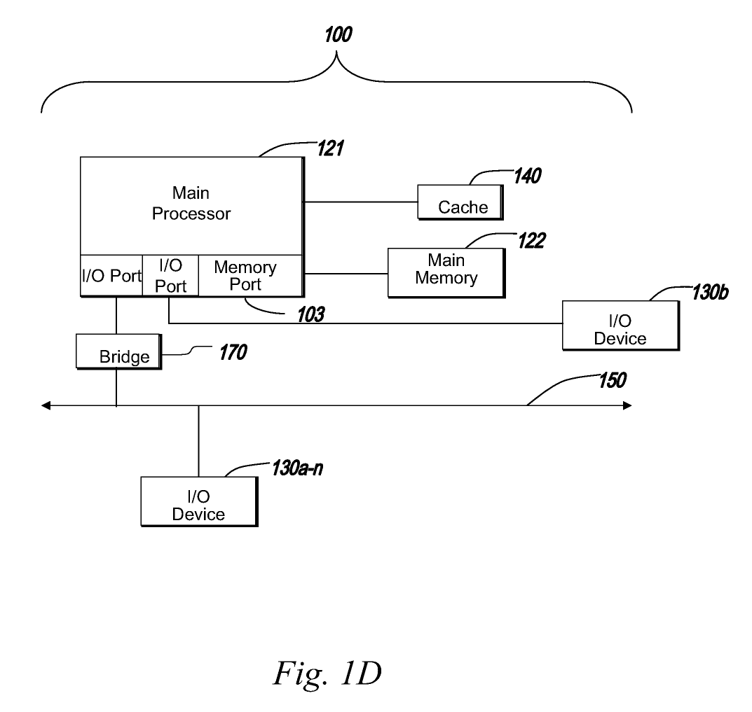

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the usage tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. System and Method for Wirelessly Determining the Usage of Cardiovascular Equipment.

The overall system and methods described herein generally relate to a system and method for determining the usage of cardiovascular exercise equipment via sensors and wireless networks. While the invention has been particularly shown and described with reference to specific embodiments, it should be understood by those skilled in the art that various changes in form and detail may be made therein without departing from the spirit and scope of the invention described in this disclosure.

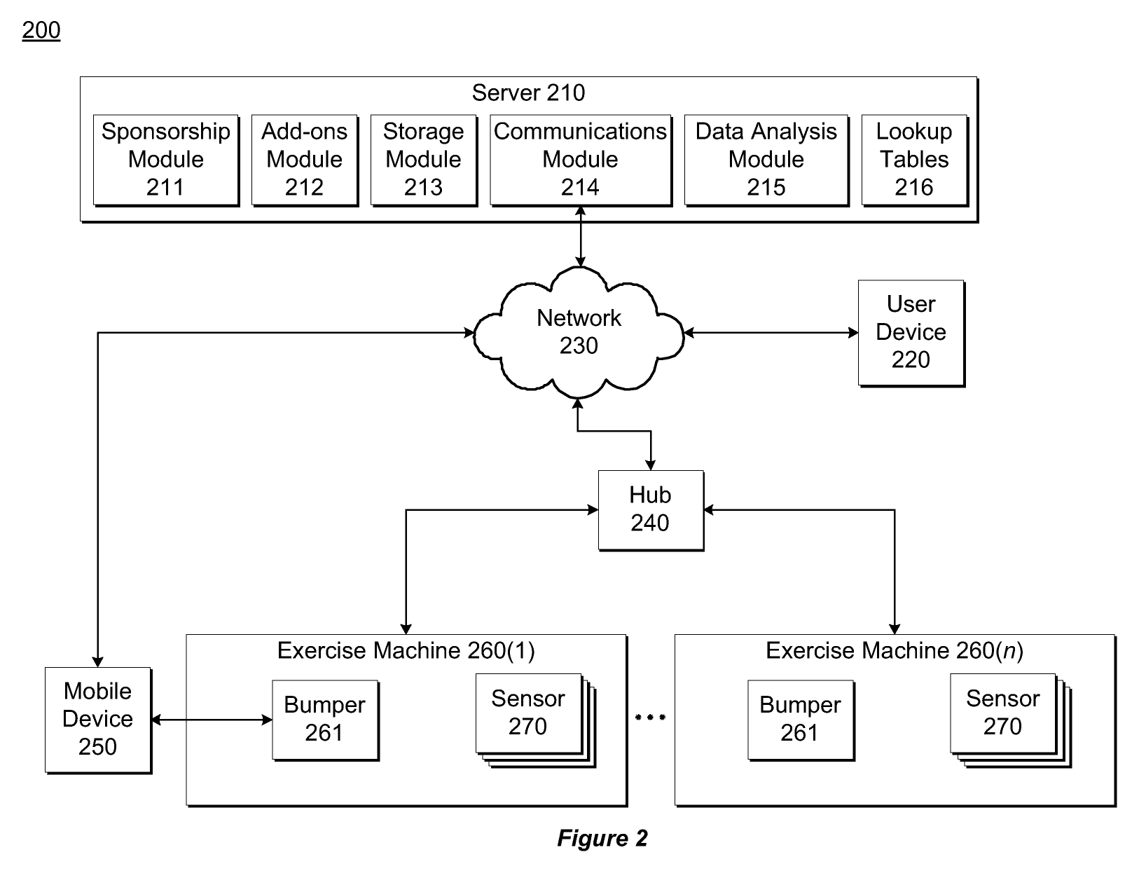

FIG. 2 is a block diagram of an embodiment of a system for monitoring usage of an exercise machine and associating the usage with a user. In a brief overview, the system 200 includes a network 230, a server 210, and at least one exercise machine 260. The server 210 may include a number of modules. The modules of the server 210 may include a sponsorship module 211, an add-ons module 212, a storage module 213, a communications module 214, a data analysis module 215, and a lookup table 216. Additionally, a user device 220 may connect to the other components of system 200 via the network 230. Subsequently, a plurality of sensors 270 and a number bumpers 261 may be attached to a plurality of exercise machines 260(1)-260(n). The sensors 270 and bumpers 261 may connect to the network 230 via a hub 240. Furthermore, the system 200 may include a mobile device 250 which activates the bumper 261 and may also connect to the remaining devices of system 200 via the network 230.

Still referring to FIG. 2, and in more detail, a server 210 in system 200 may include any type or form of a computing devices 102 described above. The server 210 may include a communications module 214. The communications module 214 may be a network interface. The interface may be any interface capable of connecting to the network 230 and communicating via any type and form of networking and/or communications protocol. For example, the network interface may include cellular, WiFi, Bluetooth, Ethernet, USB, phone, or any combination thereof.

The server 210 may also include a storage module 213. In some embodiments, the storage module 213 is responsible for storing the data received by the server 210. The storage module 213 may, but is not limited to, storing data on a hard drive, an optical drive, flash memory, solid state drive, or any combination thereof. In some embodiments, the storage module is external to the server 210. For example, the storage module 213 may be part of a network-attached storage device or external hard drive. The storage module may include any type and form of database.

Additionally, the server 210 may include an Add-ons module 212. The system 200 may allow or enable a user to associate add-ons with their user account. In some embodiments, add-on the user associated with their account are created by the user and stored in association with the add-ons module 212. In other embodiments, the add-ons are generated by a third party and the user may select add-ons to associate with their user account. In some embodiments, the add-ons are goals. For example, a user may create a goal add-on to run 15 miles in one month. Upon viewing the user interface, described below, the user may see his current progress in completing the goal.

In other embodiments, the add-on module may include personal trainer add-ons. For example, a personal trainer add-on may include specific workouts for each day of the week, or specific workouts to achieve a specific goal. The goal may be to run a marathon or to loose a specific amount of weight. In addition to the goal and personal trainer add-ons, additional add-ons may include, but are not limited to, dietary add-ons, supplemental data add-ons, or additional analysis add-ons. Supplemental data add-ons may provide a user the opportunity to track such supplemental data as weight, blood pressure, and/or hours slept per night. An additional analysis add-on may allow a user to graph or analyze usage data over periods of time or compare their usage to other groups of users.

Furthermore, the server 210 may also include a sponsorship module 211. A sponsorship may be configured to be a specific type of add-on. In some embodiments, a sponsorship is created by a company or third party willing to provide rewards to the user for achieving specific goals. For example, a company may create a sponsorship that when successfully completed awards the user with a discount on a new pair of running shows. In other embodiments, the sponsorship may be created by or for a charity. In such an embodiment, the reward would not be given to the user but to the charity. For example, charitable sponsorship module may be created that awards 10 cents to a charity for every 1 mile run by a user. The user may then have other individuals or organizations sponsor the user in the charitable sponsorship. Continuing with the example above, the user may be sponsored by 10 friends on the 10 cents/mile charitable sponsorship. Therefore, for every 1 mile the user runs, the user would generate $1.00 for the charity associated with the charitable sponsorship.

A server 210 may also include a data analysis module 215. The data analysis module 215 may include an application, service, server, daemon, routine, process or any other executable instructions executable on a device. The data analysis module may be designed and constructed for analyzing data generated and/or stored by the system, such as the server 210. In some embodiments, the data is automatically analyzed by the data analysis module 215. In other embodiments, the data is analyzed by the data analysis module 215 responsive to a request by a user. Data analysis may include analysis at the user, exercise machine, or gym level. For example, the data analysis module 215 may analyze the speed and distance a user runs on a treadmill. At a exercise machine level, the data analysis module 215 may analyze the usage of a specific piece of exercise equipment to determine its peak usage times.

In some embodiments, the server 210 may include at least one lookup table 216. The lookup tables 216 may contain data required by the data analysis module 215 to fully analyze data. For example the data analysis module 215 may refer to a lookup table 216 to obtain a user's height and weight to calculate the calories burned during a workout. Additionally, the lookup tables 216 may include data the system 200 used to determine the physical location of a specific device ID. In some embodiments, the data may be saved in a key-value relationship. In some of these embodiments, the keys may be hashed before being stored.

Still referring to FIG. 2, the system 200 may also include a plurality of exercise machines 260. As illustrated, system 200 includes n exercise machines. The exercise machines 260(1)-260(n) may be located in the same location, or in some embodiments, the exercise machines 260(1)-260(n) may be located in different locations. An exercise machine 260 may be, but is not limited to, a treadmill, an elliptical machine, a rowing machine, or a stationary bike. In other embodiments, the exercise machine 260 may be a weight machine or free weights, such as dumb bells and bar bells

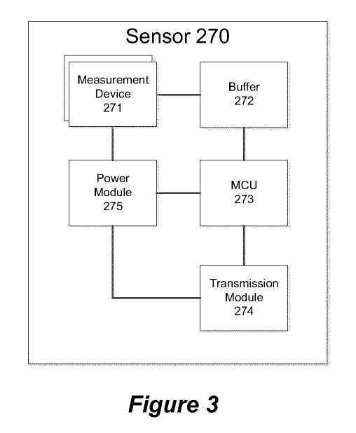

Additionally, the exercise machines 260 of system 200 may include a plurality of sensors 270. Discussed in greater detail in relation to FIG. 3, but briefly, the sensor 270 may be used to detect movement or activity of the exercise equipment. The sensor may be non-permanently attached to the exercise machines 260. Furthermore, the sensor may be wirelessly connected to the exercise machine 260. In some embodiments, the sensors 270 are incorporated into the exercise machines 260 by the manufacturer of the exercise equipment, and in other embodiments, the sensor are attached to the exercise equipment by a third party, e.g., a gym owner. In some embodiments, the sensor 270 is place on a stationary component, but monitors moving parts of the exercise equipment 260. For example, a small magnet may be placed on the tread of a treadmill. As the magnet passes a magnetic sensor the magnetic sensor may detect the passage of the magnet and record a revolution. In other embodiments, the sensor may wireless communicate with the other components of system 200. Additionally, in some embodiments, the sensor may include a magnetometer, Hall effect sensor or other such sensor capable of detecting magnetic fields. In these embodiments, the sensor may detect the motion of moving components of the exercise equipment 260.

Many types of exercise equipment 260 contain an electrical braking system that induces resistance in the spinning of the exercise equipment's flywheel. In some embodiments, the sensors may detect the electrical activity of the exercise machine's electric braking system to determine the level of resistance of a workout. In some embodiments, the motion of the user is used to generate electricity. In some of these embodiments, this electricity may be monitored. For example, on some stationary bikes the peddling of the user generates the required electricity to power the bikes' on-board computer. As the user peddles faster, the user may generate more electricity, which in turn may be monitored by a sensor 270.

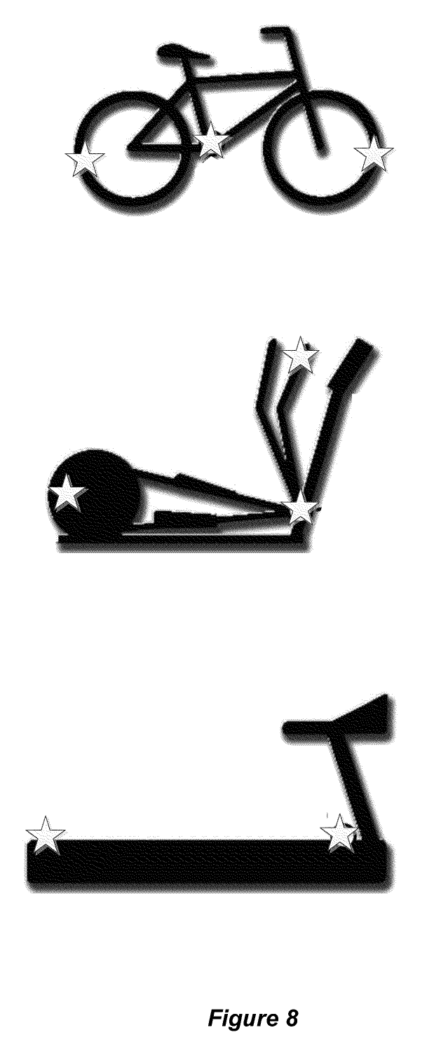

In other embodiments, the sensor 270 may be placed on a moving component of the exercise machine 260. Examples of the moving components of the exercise machine 260 may include: the peddles on of a exercise bike and/or the fly wheel of the exercise bike; the tread of a treadmill; the foot peddles, handles, and/or the moving joint of an elliptical machine; and the moving seat of a rowing machine. For example, a sensor containing an accelerometer may be placed directly on the bottom on a bike's peddle, thereby able to detect each rotation of the peddle. The stars in FIG. 8 illustrate a number of non-limiting examples for the possible placement of sensors.

As illustrated in system 200 of FIG. 2, the exercise machine 260 may also include a bumper 261. In some embodiments, the bumper 261, may provide the user with a login mechanism. When activated by the user, the bumper 261 may transmit a time stamp to the server 210. In some embodiments, this time stamp may be used to pair the collected data of a specific sensor to the user.

The bumper 261 may be attached or near the exercise machine 260. In some embodiments, the bumper 261 allows a user to associate the data generated from the sensor 270 attached to a piece of exercise equipment 260 with the user's account. The bumper 261 may include an accelerometer configured to detect a perturbation. For example, the bumper may detect when the bumper is hit by a user. In other configurations, the perturbation may be detected with a piezoelectric sensor, a proximity sensor, a photodetector, a strain sensor, stress sensor, flex sensor, or any combination thereof. In yet other embodiments, the bumper may be activated by a near field communications sensor. For example, the user may place a RFID tag near the bumper to activate the bumper or may activate the bumper with the near field communication capabilities of the user's smart phone. In some embodiments, the bumper 261 may have a touch screen or other means for the user to log in and activate the bumper 261. In some embodiments, upon activation the bumper 261 may transmit a time stamp to the server via the hub 240 and the network 230. The bumper 261 may additionally transmit a user identification and/or a machine identification to the server when activated.

In some embodiments, the bumper 261 may be battery powered or powered by AC power. In some embodiments, in other embodiments, the bumper 261 may harvest energy to completely power or to provide supplemental power to the bumper 261. The bumper 261 may enter into a sleep mode to conserve power when the bumper 261 has not detected an activation. The bumper may then wake from sleep mode when it detects a perturbation and return to sleep mode after transmitting the activation signal to the server 210.

The activation signal transmitted by the bumper 621 may contain information headers, other transmission related data, and a data payload. To minimize power consumption, the payload may contain fewer than 50, 40, 30, 20, 10, or 5 bytes of data. In an example where the pay load is 5 bytes long, the first byte may carry metadata about the exercise data. For example, the bits of the first byte may include information indicating if the data is coming from a sensor or a bumper, the priority of the data, the battery level, a sleep/wake mode of the sensor, and indicate the type of exercise equipment with which the bumper is associated. Continuing with the 5 byte example, 3 bytes may be used to indicate a unique serial number of the bumper, and the final byte may include the sensor data.

In some embodiments, the bumper 261 transmits the activation signal directly to the server 210, user device 220, and/or mobile device 250 via the network 230. In other embodiments, the bumper 261 may transmit the activation signal to the server 210, user device 220, and/or mobile device 250 via a hub 240, which is in communication with the network 230. In some embodiments the connection to the hub and/or network is wireless or wired. Wireless protocols may include WiFi, other IEEE 802 standards, Bluetooth and other such wireless communication protocols.

The system 200 may further include a mobile device 250. In some embodiments, the mobile device 250 may be a computing device 100 or commutations device 102 as described above. In some embodiments, a user may activate the bumper 261 with the mobile device 250. In some embodiments, mobile device 250 includes an accelerometer. In such an embodiment, the activation of the bumper 261 by the mobile device 250 may be accomplished by physically touching the mobile device 250 to the bumper 261. The physical contact may then be detected by the accelerometers of the bumper 261 and the mobile device 250. Responsive to the detected physical contact, the bumper 261 and the mobile device 250 may send time stamps to the server 210, which may later be used to pair the user to the exercise machine 260

In other embodiments, the time stamp may also include other information, such as user ID, machine ID, and/or location. In yet other embodiments, the activation of the bumper 261 by the mobile device 250 may include the bumper 261 or the mobile device 250 transmitting a signal to the other party with identifying information upon activation of the bumper 261, which is then transmitted to the server 210. For example, a user may tap the bumper 261 with the user's mobile device 250, which is detected by the accelerometer in each of the mobile device 250 and the bumper 261. Upon detecting the tap, the bumper 261 may transmit its unique ID code to the user's mobile device 250. The mobile device 250 may then incorporate the user ID with the bumper's ID and transmit the data to the server 210. Based on this information the server 210 can determine which exercise machine 260 a user is using. In other embodiments, the mobile device 250 may activate the bumper 261 with near field communication, proximity sensors, and/or motion sensors.

In some embodiments, the mobile device 250 may include a GPS module. In such an embodiment, the mobile device 250 may transmit a location to the server 210 upon activation of the bumper 261. Additionally, the mobile device 250 may monitor exercises not preformed on an exercise device 260 with a plurality of onboard sensors. For example, the user may indicate to the server, via the mobile device 250, that the user is engaging in cardiovascular exercise independent of an exercise machine 260, such as a jogging outside. The mobile device 250 may transmit location and accelerometer data to the server 210. Based on this data the server 210 and/or mobile device 250 can determine parameters about the exercise. For example, it may determine the path of the jog, average and specific speeds, distance traveled, duration of workout, steps take, or any combination thereof.

In yet other embodiments, a dongle may be attached to the mobile device 250. The dongle may be configured to activate the bumper 261. In some embodiments, the dongle includes the sensor described above attributed to the mobile device 250.

In some embodiments, the generation of the time stamp and/or the activation of the bumper 261 is accomplished by a programming running on the mobile device 250. In some embodiments, the program generates the time stamp responsive to detecting that the mobile device 250 physically contacted the bumper 261. Additionally, the program may allow the user to log exercise activity independent of an exercise machine. For example, if a user jogs around town for 30 minutes, the program may allow the user to enter the specifics of that exercise into the program, which in turn is transmitted to the server 210. In some embodiments, the program may be configured to complete any, or all of the steps required to associate a user's activity with the data collected by sensor 270.

Still referring to FIG. 2, system 200 may also include a hub 240. In some embodiments, the hub 240 receives transmissions from the sensors 270 and/or bumper 261 in system 200. The hub may communicate with the bumpers 261 and/or sensors 270 via wired or wireless communications. For example, and as described above, the hub 240 may receive communications from the bumpers 261 and/or sensors 270 via WiFi or other IEEE 802 wireless transmission protocols. Additionally, the hub 240 may have a 3G and/or 4G radio which it uses to communicate to the server 210 via the network 230.

In some embodiments, the hub 240 receives data from the bumpers 261 and/or sensors 270 and formats the data before transmitting the data to the server 210. For example, the hub 240 may convert the data into a JavaScript Object Notation (JSON), XML, Comma Separated Values (CSV), or other such data serialization format. In some embodiments, formatting the data may also include performing analysis. For example the hub 240 may calculate the distance a user runs on a treadmill in one hour and transmit the result of that calculation to the server 210. Additionally, the hub 240 may low-pass or high-pass filter data before transmitting the processed data to the server 210. The hub 240 may also perform other calculations on the data such as peak counting and Fourier transforms of the data.

Additionally, the hub 240 may prioritize data. For example, the data may be prioritized has a high priority or low priority. High priority data may include data that is time sensitive, while low priority data may be time insensitive. For example, time sensitive data may be from a request for which a user is awaiting a reply, such as if their login was successful, while time insensitive data may be data that will be processed at a later date. High and low priority data may be sent to the server at the same time, but processed at different times. In other embodiments, the high data may be immediately sent, or pushed, to the server, while the low priory may be sent to the server 210 intermittently or at specific times.

In yet other embodiments, the hub 240 may store data for periods of time before transmitting the data to the server 210 via the network 230. For example, the hub 240 may have a buffer, which it waits until is full before transmitting the data to the server 210. Additionally, the hub may have a small storage device similar to the storage device 128 of FIG. 1. The hub may store data on the storage device between transmissions to the server 210 or during periods of lost connectivity to the network 230.

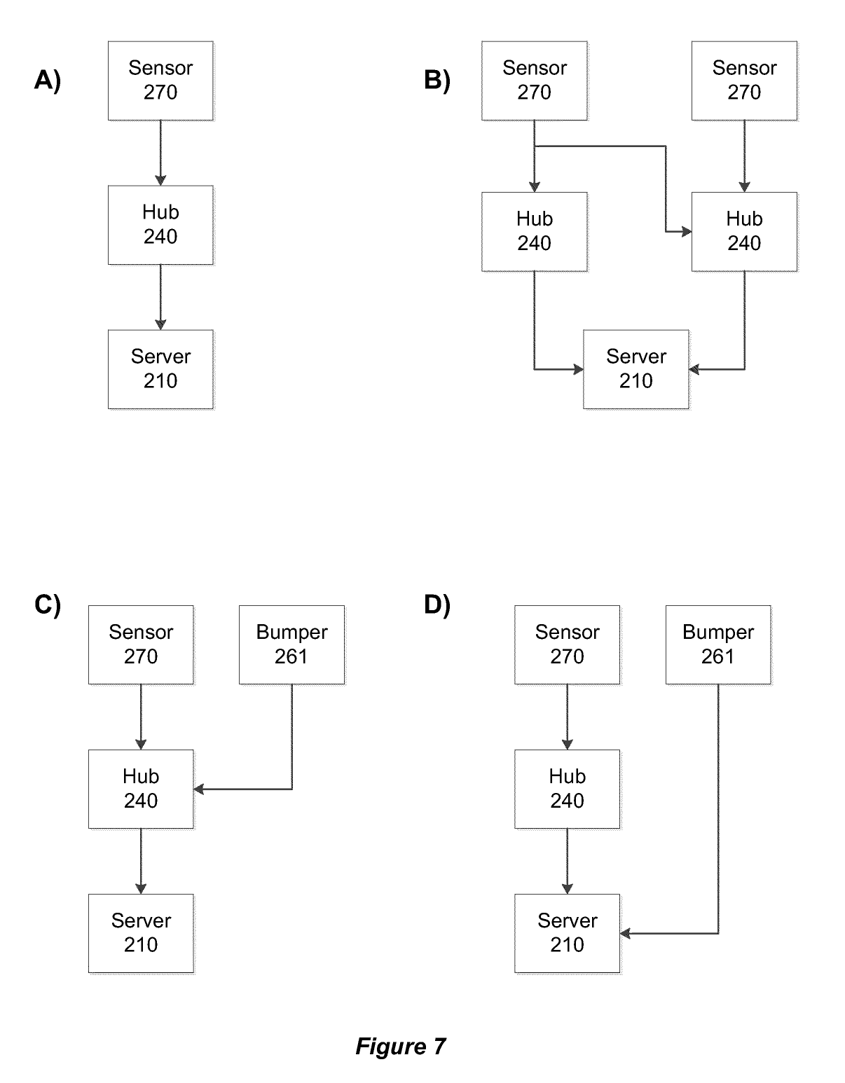

FIG. 7 illustrates a number of exemplary embodiments of network configurations involving a hub. FIG. 7A, a non-limiting, exemplary example, illustrates at least one occupancy sensor 270 using wireless transmission to relay information to a hub 240. This hub 240 then uploads the data generated by the sensor 270 to the remote server 210 using WiFi or other wireless protocol.

FIG. 7B illustrates a second, non-limiting, exemplary example. In this example, the system includes two or more sensors 270. These sensors may not necessarily pair to a specific hub in the event of multiple hubs 240. This may result in hubs 240 that can receive wireless transmissions from multiple sensors 270. Both hubs 240 are capable of uploading their received information to a remote server 210. Additionally, in a similar example multiple sensors 270 and multiple hubs 240 may be used. For example, a first hub 240 may receive transmissions from a plurality of sensors 270, while a second hub 240 only receives transmissions from one sensor 270. This could be the result of the arrangement of sensors 270 and hubs, such that the wireless coverage of the devices does not overlap uniformly. Additional, physical objects may impede the wireless transmission from the sensors 270 or hubs 240. In some embodiments, a hub 240 is configured to only receive transmissions from a specific group of sensors 270.

In some embodiments, there may be sufficiently hubs and sensors to outfit each exercise machine of a gym with at least one sensor.

FIG. 7C illustrates an example, which includes a bumper 261. In this example, the hub 240 receives input from one or more sensors 270 as well as one or more bumpers 261. As illustrated by FIG. 7C, the sensor 270 and bumper 261 may transmit data wirelessly to the same hub 240.

In some embodiments, as the hub 240 receives information from both the sensor 270 and a bumper 261, it uploads this information to a remote server 210 as described previously. The sensor 270 data is then paired with the bumper 261 data if possible, in which case the specific user whom activated the bumper 261 would be able to access the data provided by the sensor 270.

In a final exemplary example, FIG. 7D illustrates another embodiment utilizing the bumper 261. Here, the bumper 261 communicates directly with the remote server 210, bypassing the hub 240. However, in some embodiments, the sensor 270 still directly communicates with the hub 240. In some embodiments, the bumper 261 may be a QR code or some other means to communicate machine identity to a mobile phone or similar device. For example, the mobile device 250 may scan the barcode, which identifies the machine to the mobile device 250. The mobile device 250, may transmit the machine identification to the server 210. The bumper 261 may allow the user to input specific information such that the user can be identified by checking the specific information against a database. In some embodiments, the pairing of sensor data to the specific user may be done at the remote server 210 and/or the hub 240.

The system 200 may also include a user device 220. Similar to the mobile device 250 of system 200, the user device 220 may include devices such as computing device 100 and communication device 102 from FIG. 1. From the user device, a user may view the data from previous or current workouts. In some embodiments, data from the sensors 270 can be sent directly to a user device 220 or a mobile device 250; however, in some embodiments, a user may view data stored on the server 210.

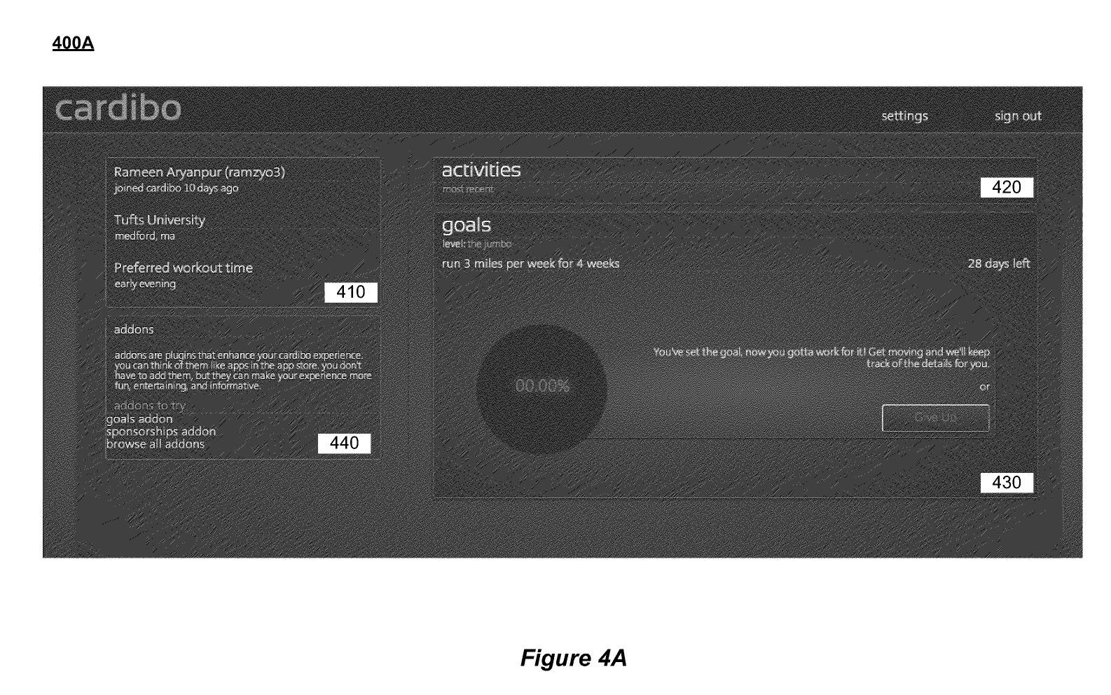

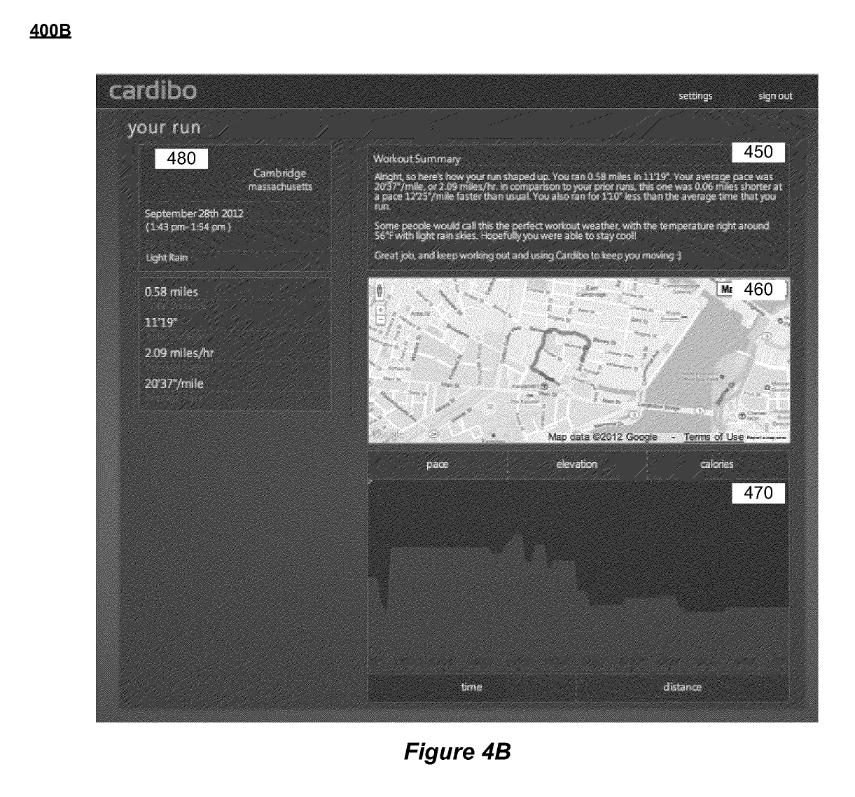

The data may be viewed through an application native to the OS running on the user device 220. In other embodiments, the information may be viewed through a web browser. Described in greater detail in relation to FIGS. 4A and 4B, but described briefly, the web browser interface may allow the user to view and analyze data regarding previous or current workouts. Additionally, using the user device 220, the user may view and edit workout goals, available sponsorships, and/or add-ons described above.

FIG. 3 provides greater detail of the sensor 270 from system 200. The sensor 270 may include at least one measurement device 271. Additionally, the sensor 270 may include a microcontroller (MCU) 273 and a buffer 272. The sensor 270 may be powered by a power module 273, which provides power to each of the components of the sensor 270. Furthermore, the sensor 270 may include a transmission module 274 for communicating with the hub, network, and/or other components of system 200.

The MCU 273 may be any type of CPU 121 as described above in relation to FIG. 1. In some embodiments, the MCU 273 is configured to run in a power saving configuration. For example, the MCU 273 may be configured to have sleep mode, in which it consumes little or no power. Furthermore, the MCU 273 may be configured to wake only temporally to perform functions such as transmission of data via the transmission module 274 or to instruct a measurement device 271 to collect data.

Still referring to FIG. 3, the sensor 270 may also include a buffer module 272. The MCU 273 may store data in the buffer 272 between transmissions. Additionally, the measurement device 271 may be configured to directly store data to the buffer 272. In some embodiments, the buffer may be part of the MCU 273 and/or the measurement device 270. In other embodiments, the buffer module 272 may be an individual module, as depicted in FIG. 3.

In some embodiments, the measurement device 271, may be configured to fill the buffer, and then once the buffer 272 is full to wake the MCU 273. Responsive to this request, the MCU 273 may transmit the data in the buffer via the transmission module 274. Additionally, the MCU 273 may be configured to process the data before transmitting it to the server 210, hub 240, or mobile device 250. For example, the MCU 273 may low-pass or high-pass filter the data, perform counting functions, perform mathematical operations such as data scaling or fast Fourier transforms, or any combination thereof.

Additionally, the sensor 270 may include at least one measurement devices 271. In some embodiments, the plurality of measurement devices 271 may all be the same type of measurement device 271 or they may include different types of measurement devices 271. The measurement devices 271 may be an accelerometer, magnetometer, vibration sensor, optical sensor, Hall Effect sensor, photodiode or other such sensor.

Still referring to the sensor 270 of system 200, the sensor 270 may also include a power module 273. The power module 275 may be a battery or AC power. In some embodiments, the power module 275 may harvest energy to completely power the power module 275 or to supplement battery power. The power module 275 may harvest energy from ambient vibrations, wind, heat, or light.

Furthermore, the sensor 270 of system 200 may include a transmission module 274. The transmission module 274 allows the sensor to communicate with the various components of system 200. The transmission module 274 may be a network adapter, which allows the sensor 270 to communicate over a wired network. Additionally, the transmission module may be a wireless radio, such that it may allow the sensor 270 to communicate wirelessly. For example, communications module may allow the sensor to communicate over WIFI or any other IEEE 802 standard. In some embodiments, the sensors 270 communicate directly with the hub 240 or server 210. In other embodiments, the sensors 270 create an Ad-Hoc network, and may transmit data to other sensors or multiple hubs.

FIGS. 4A and 4B illustrate non-limiting, exemplary embodiments of possible web pages as may be accessed by mobile devices 250 and/or user devices 220 of system 200. FIG. 4A, illustrates an exemplary embodiment of a main page 400A. The main page 400A can include a plurality of modules. For example, the main page 400A contains four general modules. The modules may map directly or indirectly to the modules of the server 210, or in some embodiments the modules may map to a plurality of the server 210 modules. For example, the add-on module 440 may map to the add-on module 212 and/or the sponsorship module 211 of the server 210.

As illustrated, the first module of the main page 400A is the user information module 410. The user information module 410 may display a user's name and/or a user ID. The user information module 410 may also display other basic user information such as age, weight, percent body fat, location, preferred workout time, preferred workout location, and any combination thereof. Additionally, in some embodiments, the user information module 410 may also display an affiliation of the user. For example, the user may use the components of system 200 as part of an affiliation with a specific gym, school, university, training plan, corporate wellness plan, and/or physical therapy plan. In some embodiments, the user may share his data with other members related to his affiliation.

Secondly, the main page 400A illustrates an activities module 420. The activities module 420 may display the last, or a list history of, the user's past activities. For example, the activities module 420 may display the previous 5 exercises the user performed. In some embodiments, the user can select the activities module 420, and the web page will display detailed information about the activities.

Thirdly, the main page 400A illustrates a goals module 430. In some embodiments of system 200, a user may set one or more goals. The goals may be to run a certain number of miles in a month or to run a certain number of miles every day. In some embodiments, the user may compete with another user (or users) to achieve the goal first. In yet other embodiments, a first and a second user may collaboratively work together to complete a goal.

Fourthly, the main page 400A illustrates an add-ons module. Via the add-ons module 440, a user may view, add, and/or edit their add-ones. Add-ons may include widgets that perform specialized analytics on a user's data and displays the data. Additionally, add-ons may include sponsorships, as mentioned above. FIG. 4B illustrates an exemplary embodiment, of an activities subpage 400B of the main page 400A. The activities subpage 400B may be accessed by clicking on the activities module 420 of main page 400A. Similar to the main page 400A, discussed above, the activities subpage 400B contains a number of modules that provide a user with additional information.

For example, the activities page 400B may include a workout summary module 450. In some embodiments, the workout summary 450 may have an overview of the selected activity. In some of these embodiments, the summary may be provided in prose and/or in tabular format. The summary may include information on the weather during the activity, distance traveled, time of activity, calories burned during the activity, speed during activity, date and time of activity, or any combination thereof. In some embodiments, when the activity occurred outside, such as an outside jog, a map 460 may supplement the workout summary 450. The map 460 may indicate the path traveled during the activity and distance traveled.

Furthermore, additional information may be provided to the user in a graphical format by a graphing module 470. In some, embodiments, the graphing module may display to the user plots of place, elevation, and calories burned over the duration of the run. In some embodiments, the user can select markers in the route displayed in the map 460 and the graph 470 adjusts to show the data relating to that time point in the route.

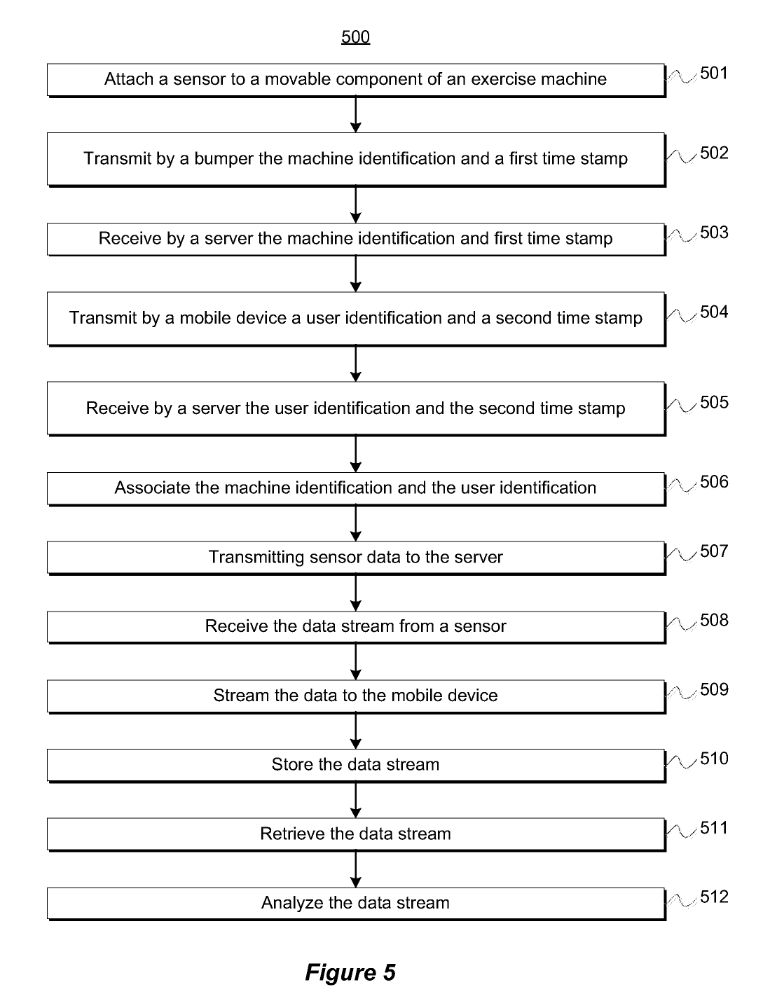

FIG. 5 is a flow chart of method 500 to monitor the usage of an exercise machine and associating the usage with a user using a system as described in FIG. 2. The method includes attaching a sensor to a moveable component of an exercise machine (step 501). The method 500 also includes transmitting by a bumper a machine identification and time step (step 502) and receiving the machine identification and time stamp by a server (step 503). Transmitting, by a mobile device (step 504) and then receiving, by a server, (step 505) a user identification and a second time stamp. Responsive to receiving the first and second time stamp, the machine identification and user identification are associated with one another (step 506). The method 500 further includes transmitting data to a server (step 507) and receiving, by the server, the data (step 508). In some embodiments, the data is streamed to a mobile device (step 509). Responsive to the server receiving the data, the data is stored (step 510). The stored data can be retrieved (step 511) and analyzed (step 512) by the server or other components of system 200.

Is the language from the dependent claims all somewhere below in a corresponding step?

As set forth above, in some embodiments, at step 501 of method 500, a sensor is attached to a moveable component of an exercise machine. As discussed above in relation to FIG. 2, at least one sensor, such as sensor 270, is attached to an exercise machine. The sensor may be attached directly to a moveable component of the exercise machine or the sensor may be attached in such a way that the sensor can monitor a moveable component of the exercise machine. The sensor may contain at least one of an accelerometer, vibration sensor, optical sensor, and magnetic field sensor.

At step 502, a bumper transmits a machine identification and a first time stamp. When a user decides to use a specific piece of exercise equipment, the user may activate a bumper. The user may activate the bumper with a mobile device. Upon activation of the bumper, the bumper may transmit a first time stamp. In some embodiments, the bumper may also include metadata or additional data with the transmitted time stamp and machine identification. The bumper may transmit the data to a server via a network and/or hub. In some embodiments, the bumper is activated when the user physically contacts the bumper with the user's mobile device. In other embodiments, the user may log into the bumper using a touch screen or another login method, such as activating with a ID card containing a RFID chip.

At step 503, a server receives the machine identification and the first time stamp. Responsive to the data being transmitted by the bumper, the server receives the first time stamp and machine identification. The server may then hold the first time stamp and the machine identification in a queue. In some embodiments, the server may match the first time stamp with a second time stamp.

At step 504, a mobile device transmits a user identification and a second time stamp to the server. As discussed above, the user may activate the bumper with the user's mobile device. The user's mobile device may be configured to execute a program. In some embodiments, the program allows the user to enter log in information, such as a user name and password. Upon activation of the bumper by the user physically contacting the bumper with the user's mobile device, the program detects the physical contact using the sensors of the user's mobile device. Responsive to detecting the physical contact, the mobile device transmits a second time stamp and a unique user identification to the server. In some embodiments, the program executing on the mobile device may also gather GPS information and transmit the GPS location in addition to the second time stamp and user identification. In other embodiments, location may be determined by the IP address of the mobile device, near-by cell towers, and/or near-by WiFi signals.

At step 505, the server receives the second time stamp and the user identification. Responsive to receiving the second time stamp and the user identification, at step 506, the server associates the machine identification to the user identification. In some embodiments, the association may occur by analyzing the probability of two time stamps being generated at the same time. For example, the activation of the bumper by the user's mobile device, may create the first and second time stamps at substantially the same time. The server may then compare a plurality of incoming first time stamps from bumpers to a plurality of incoming second time stamps from mobile devices. The server may associate a first and a second time stamp when the first and second time stamp have substantial the same time of generation. In some embodiments, the generation of the first and second time stamps must be within a predetermined and/or configurable time period of each other, such as 1, 5, 10, or 15 ms of each other for the system 200 to associate the user identification with the machine identification. In some embodiments, the location transmitted with the second time stamp and user identification may be integrated into the association step. For example, after receiving the first time stamp and the machine identification, the server may use a lookup table to determine the location of exercise machine associated with the machine identification. Using the location from the machine identification lookup table and the location information accompanying the second time stamp, the server may limit the search for matching time stamps to time stamps generated in the same location. This may limit the number of possible associations and limit the number of possible first and second time stamps that must be compared to determine a correct association. In some embodiments, the location information may only be used when conflicts arise. For example, the server may receive a first time stamp with a UNIX time stamp of 1352122573.50, and two second time stamps (one with a UNIX time stamp of 1352122573.55 and one with a UNIX time stamp of 1352122573.49). In this example, both second time stamps have a high probability of matching the first time stamp. Therefore, the server may also refer to the location data. For example, the server may determine one second time stamp originated from New York City, N.Y. and the other originated from Spokane, Wash. Having determined the machine identification is associated with a piece of exercise equipment located in Spokane, Wash., the server may associate the first time stamp with the second time stamp, which originated from Spokane, Wash. Upon associating the first time stamp to the second time stamp, the sever may associate all incoming data from the exercise machine associated with the first time stamp to the user account associated with the second time stamp.

At step 507, the sensor transmits data to the server. As described above, the sensor collects and transmits data. In some embodiments, the sensor may transmit the data to a plurality of servers, mobile devices, and/or user devices. The sensor may stream the data or the sensor may send the data at intermittent intervals. In some embodiments, the sensor may transmit data to the server when a user is not associated with the exercise equipment. In some embodiments, the sensor may only transmit data to the server when a user is associated with the exercise equipment. In other embodiments, the sensor may transmit data to the server independent of the associated exercise machine being active. In some of these embodiments, the sensor may transmit data to the server less frequently when a user is not associated with the exercise machine. For example, when the exercise machine is not in use, the sensor may transmit data to the server once every 15 minutes, and then return to a sleep mode; however, if a user is actively, using the exercise equipment, the sensor may transmit data ever 30 seconds.

Responsive to the data being transmitted by the sensor, at step 508, the server receives the data. The server may store the sensor data in association with the user identification paired to the sensor from which the data is coming. The data stream may include machine and/or sensor status data. In some of these embodiments, the server may discard the received data if a user is not actively paired with the exercise machine. In other embodiments, the server may store this data without a user association when no user is actively using the exercise machine. In some embodiments, the sensor data is received and stored prior to being associated with a user. By saving the data from the sensor when the exercise machine is not in use, peak and non-peak times for the exercise machine may be calculated. Additionally, a user may log into the system to determine the current availability of exercise equipment at the user's local gym.

At step 509, the system may stream the data to a mobile device. In some embodiments, the system may stream the data to a mobile device from the server, while in other embodiments the data may be streamed directly from the sensor, hub, and/or other device such as a second mobile device or user device. The system may stream analysis from the sensor data back to the mobile device. For example, if a user is running on a treadmill, the system may transmit data back to the user's mobile device, and display to the user the user's current speed, distance traveled, and the incline setting of the treadmill. In some embodiments, the data may be displayed to the user graphically and/or in text format.

At step 510, the system stores the data. In some embodiments, the data is stored in the storage module 213 of the server. In some embodiments, the data may be saved alternatively, or additionally, on the mobile device and/or user device. The system may process the data before it is stored. For example, the data may be passed through a low-pass filter before being stored. In some embodiments, the original data and/or the processed data is stored for later retrieval.

At step 511, the system may retrieve the data, and then at step 512 analyze the data. In some embodiments, the system may perform analysis on the data when requested by the user. For example, via the user interface described above, the system may provide the user with a detailed description of the activities the user performed over the past month. In another example, the system may provide the user with monthly totals of distance traveled or calories burned while exercising. In some embodiments, the user may allow the data to be accessed by a employer or insurance company. For example, an insurance company or employer may provide an employee with discounts on health insurance if the employee regularly exercises.

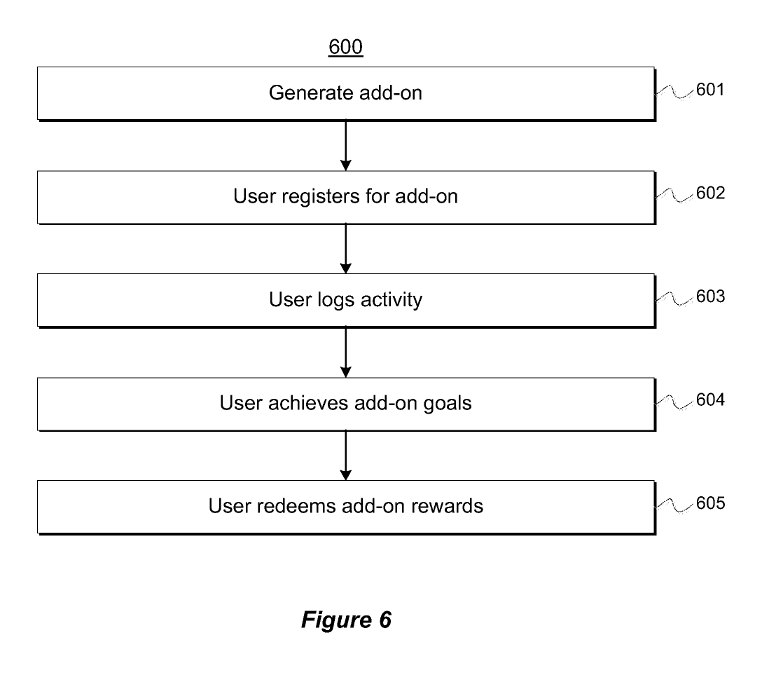

FIG. 6 is a flow chart of method 600 to generate and use add-ons in a user account of the system as described in FIG. 2. The method 600 includes generating an add-on (step 601). Additionally, the method includes the user registering for an add-on (step 602). The method 600 also includes the user logging activity (step 603). Response to logging enough activity the user achieves the add-on goal (step 604), and response to achieving the add-on goal, the user redeems the add-on rewards (step 605).

As set forth above, the method 600 includes generating an add-on. As described above, an add-on may include a specific activity such as a goal (e.g., running 10 miles in one month). Add-ons and goals may be persistent or a one-time occurrence (e.g., run a total of 10 miles every month or run 10 miles in a month). In some embodiments, the add-on may be created by a user. In other embodiments, the add-on may be created by the system, a second user, or a company. For example, the add-on may be created by a ground of employees wishing to challenge a second group of employees to collectively run 1,000 miles. Additionally, in some embodiments, add-ons may be sponsorships to accomplish specific goals. For example, add-on may be created by a charity, and a user can sign up for the add-on and people may sponsor the user to run a specific distance in a given amount of time. In another sponsorship example, a company may create an add-on. In this example add-on, the company may provide a user with a discount for athletic gear upon finishing the goal associated with the sponsorship add-on. For example, Nike may create a sponsorship add-on, in which they provide a user with 5% off new running shoes for every 100 miles the user runs.

At step 602, the user registers for the add-on. As stated above, the user may register for an add-on created by the user or by a third party. In some embodiments, the user many register for a plurality of add-ons. In other embodiments, the user may register as part of a group, such that the user's totals are collectively added to the completion of a add-on goal.

At step 603, the user logs the exercise activity. In some embodiments, this step is automatically handled by the system 200. For example, when a user activates a bumper on an exercise machine, the activity of that exercise machine is automatically logged to the user's account, and accordingly countered towards the user's add-ons. In some embodiments, the user may automatically log outdoor exercise activity with a program on the user's mobile device, as described above.

In some embodiments, the system 200 may be configured to ensure a user is accurately completing the exercise before logging the data. For example, in an embodiment when the user is logging the distance run with the user's mobile device, the mobile device may compare the accelerometer data during the run to expected values. The mobile device may record accelerometer data from the mobile device to determine if the mobile device experienced impacts indicative of a user running a the rate which the system 200 detected. If the mobile device does not detect the impacts, it may infer the user activated the program and then drove around in a car to try to trick the system 200 into thinking the user was running. Similarly, the sensor attached to a treadmill may detect impacts associated with a runner running, to ensure the runner did not leave the treadmill on without running on the treadmill.

Responsive to achieving the add-on goals at step 604, the user redeems the add-on rewards at step 605. As described above, some add-ons have an associated reward with the completion of the add-on. In such an embodiment, the use may receive the reward upon completion of the add-on. For example, if a user registers for a sponsorship add-on with Nike for a 5% discount, upon completing the sponsorship add-on a coupon for 5% off may be e-mailed to the user. In other embodiments, the coupon may be physically mailed or available to the user through a program on the user's mobile device. In other embodiments, the reward may be associated with the user's account, and the user may purchase athletic gear through a website associated with the system 200.

The skilled artisan will understand that, although the functions are shown in a particular order, they can be done in any order, or certain steps may be skipped entirely.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementations,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the criteria, combination indicators and queries can be provided in Boolean form or other languages, tree structures, or contextual query languages or grammar forms. Content can be identified for display on web pages or with other information resources such as websites, domain names, or uniform resource locators. Further, identifying content for display with web pages or other information resources can include identifying content as being suitable for display (e.g., as a candidate for display) with the information resource. The suitable content can be evaluated against other suitable content, e.g., in an auction, with a winning content item selected from the auction and provided for display with a rendering of a web page or other information resource. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed:

1. A method for monitoring usage of an exercise machine and associating the usage with a user, the method comprising:
receiving, by a server, a user identification;
receiving, by the server, a machine identification of an exercise machine in response to an activation of a bumper;
associating the user identification with the machine identification based on a time of receipt of the user identification and a time of receipt of the machine identification;
receiving a data stream from a sensor sensing a moveable component of the exercise machine; and
storing the data stream in association with the user identification.

2. The method of claim 1, wherein the sensor is at least one of an accelerometer, vibration sensor, optical sensor or magnetic field sensor.

3. The method of claim 1, further comprising receiving, by the server, the user identification from a user's mobile device.

4. The method of claim 3, further comprising activating the bumper by the user's mobile device.

5. The method of claim 3, further comprising transmitting the data stream to the user's mobile device.

6. The method of claim 1, further comprising generating a first time stamp associated with the user identification and a second time stamp associated with the machine identification after activation of the bumper.

7. The method of claim 1, wherein the data stream comprises sensor data, the machine identification, and sensor status data.

8. The method of claim 6, further comprising associating the user identification with the machine identification based on the first and second time stamp.

9. The method of claim 1, wherein receiving the data stream occurs prior to the receiving of the user identification.

10. The method of claim 1, further comprising associating the user identification with the machine identification based upon a GPS location of the user.

11. A method for monitoring usage of an exercise machine and associating the usage with a user, the method comprising:
monitoring, with a sensor external to an exercise machine, a moving component of the exercise machine;
transmitting, by the sensor, a data stream comprising at least one of a machine identification of the exercise machine and the sensor measurements of the moving component of the exercise machine;
transmitting, by a bumper, a machine identification and a first time stamp in response to the bumper being activated by a mobile device; and
transmitting, by the mobile device, a user identification and a second time stamp in response to the mobile device activating the bumper.

12. The method of claim 11, wherein the sensor is at least one of an accelerometer, vibration sensor, optical sensor and magnetic field sensor.

13. The method of claim 11, wherein the sensor is non-permanently attached to the exercise machine.

14. The method of claim 11, wherein the sensor goes into a sleep mode when the moving component of the exercise machine is not moving.

15. The method of claim 11, further comprising transmitting, by the mobile device, a user GPS location.

16. The method of claim 11, wherein the data stream further comprises a sensor status.

17. The method of claim 11, further comprising receiving, by the mobile device, the data stream.

18. The method of claim 11, wherein the data stream is transmitted to a hub.

19. The method of claim 18, wherein the hub transmitted the data stream to a server.

20. The method of claim 11, wherein the bumper contains one of a proximity sensor and an accelerometer.
